(19) United States
(12) Patent Application Publication
(10) Pub. No.: US 2023/0252340 A1
(43) Pub. Date: Aug. 10, 2023

(54) Real Time Monitoring and Smart Ingestion of Models Using an Augmented Reality Distributed Ledger with Edge Computing

(71) Applicant: Bank of America Corporation, Charlotte, NC (US)

(72) Inventors: Kalyanasundaram Ramanathan, Chennai (IN); Vasuki Anand, Chennai (IN)

(21) Appl. No.: 17/666,207

(22) Filed: Feb. 7, 2022

(51) Int. Cl. G06N 20/00; G06T 19/00

(52) U.S. Cl. CPC G06N 20/00; G06T 19/006

(57) ABSTRACT

Aspects of the disclosure relate to computing hardware and software for ML model selection and AR. A computing platform may select a ML model. The computing platform may send, to an AR client device, an AR representation of the ML model that illustrates operation of the ML model. The computing platform may receive, from the AR client device, consent information indicating whether or not consent is provided to apply the ML model. Once consent is received, the computing platform may: 1) write, to a distributed ledger, the consent information and a identifier of the ML model, 2) apply the ML model to produce a ML output customized based on a user of the AR client device, and 3) send, to the AR client device, commands directing the AR client device to display the ML output, which may cause the AR client device to display the ML output.

### BACKGROUND

Aspects of the disclosure relate to computing hardware and software, particularly distributed computing hardware and software enabled with machine learning capabilities. In some instances, machine learning models may be used to perform analysis, make predictions, provide recommendations, and/or perform other functions. In these instances, inputs may be provided to a particular machine learning model, which may be used by the model to produce an output. This output may subsequently be provided to a user, machine, and/or otherwise output. In these instances, however, the recipient user or machine may be blind to the operations and/or initial selection of the machine learning model itself, and might not understand or be informed of how the model operates, why the model was selected, what model was used, and/or otherwise. This may, in some instances, lead to sub-optimal machine learning analysis due to the use of an unwanted or not preferred model (e.g., due to a mode of analysis, necessary inputs, consumed processing resources, and/or other model attributes, parameters, or characteristics). As the prevalence of machine learning increases, it may be important to improve the process of model selection, prior to application of selected models, to provide optimal outputs and conserve processing resources.

### SUMMARY

Aspects of the disclosure provide effective, efficient, scalable, and convenient technical solutions that address and overcome the technical problems associated with developing and implementing computer hardware and software that performs machine learning (ML) model selection. In accordance with one or more embodiments of the disclosure, a computing platform comprising at least one processor, a communication interface, and memory storing computer-readable instructions may select, once an augmented reality (AR) session has been established with an AR client device, a ML model, which may be configured to produce an output based on user information. The computing platform may send, to the AR client device, an AR representation of the ML model, which may illustrate, using AR, operation of the ML model. The computing platform may receive, from the AR client device, consent information indicating whether or not consent is provided to apply the ML model. Based on identifying that consent has been received, the computing platform may: 1) write, to a distributed ledger, the consent information and an identifier of the ML model, 2) apply the ML model to produce a ML output customized based on a user of the AR client device, and 3) send, to the AR client device, one or more commands directing the AR client device to display the ML output, which may cause the AR client device to display the ML output. Based on identifying that consent has not been received, the computing platform may: 1) select an alternative machine learning model, which may be configured to produce the output based on the user information, 2) send, to the AR client device, an AR representation of the alternative ML model, which may illustrate, using AR, operation of the ML model, 3) receive, from the AR client device, second consent information indicating that consent is provided to apply the alternative ML model, 4) write, to the distributed ledger, the second consent information and a identifier of the alternative ML model, 5) apply the alternative ML model to produce an alternative ML output customized based on the user of the AR client device, and 6) send, to the AR client device, one or more commands directing the AR client device to display the alternative ML output, which may cause the AR client device to display the alternative ML output.

In one or more instances, the AR representation of the ML model may be configured to be manipulated based on user input received via the AR client device, where the manipulation of the AR representation further illustrates the operation of the ML model. In one or more instances, the user input may be a selection of the alternative ML model.

In one or more examples, the computing platform may receive an indication of the selection of the alternative ML model. The computing platform may update the AR representation of the ML model based on the selection of the alternative ML model, which may configure the AR representation of the ML model to illustrate operation of the alternative ML model.

In one or more instances, the AR client device may be one or more of: a mobile device, a tablet device, or AR glasses. In one or more instances, the distributed ledger may be one of: a blockchain or a holo-chain.

In one or more examples, the AR session may be established in response to receipt of an unprompted indication of the ML model. In one or more examples, the AR session may be established in response to selection of the ML model by the user of the AR client device.

In one or more instances, the AR client device may be one or more edge nodes, and communication between the computing platform and the AR client device may occur via the one or more edge nodes. In one or more instances, illustrating the operation of the ML model may include illustrating a preview of the ML output.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment configured to perform real time monitoring and smart ingestion of machine learning models using augmented reality in accordance with one or more example embodiments;

FIGS. 2A-2E depict an illustrative event sequence for performing real time monitoring and smart ingestion of machine learning models using augmented reality in accordance with one or more example embodiments;

FIG. 3 depicts an illustrative method for performing real time monitoring and smart ingestion of machine learning models using augmented reality in accordance with one or more example embodiments; and

FIG. 4 depicts an illustrative graphical user interface associated with real time monitoring and smart ingestion of machine learning models using augmented reality in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. In some instances, other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As a brief introduction to the concepts described further herein, one or more aspects of the disclosure relate to improved transparency and illustration of machine learning models and their operations. In some instances, machine learning models and algorithms may be built and ingested into a production environment. Once the models come to a live environment, the outcomes, insights, and/or decisions of the models might not indicate to users what algorithm was selected, why it was picked, and/or how the outcomes/decisions were made. It may be important to make such models more transparent and explainable using robust technology.

Accordingly, as part of model ingestion, model representation generation apparatus as described herein may enable users to use augmented reality (AR) to initiate a Merkle tree protocol with edge computing on the fly to decide on model ingestion. For example, a user may receive a model/batch/patch on a device (mobile device, smart watch, laptop, and/or other device) either as a system push or user pull. The user may initiate an augmented reality experience using head gear or other augmented reality equipment with built in model representation generation capabilities, which may include modules corresponding to execution history, script files, scheduling, data collection, analysis, parameter engine, metadata, data orchestration, resolution and/or other modules. For example, vector information may be used by nodes for approval, learning, and/or calibrating with a central cloud, and logs may be stored in the edge node. These modules may be activated and initiated in augmented reality. The parameter engine may dissect the model for nodes and users to view the local privacy, global privacy, fairness, non-variability, hidden beneficiaries, and/or other information. The instant resolver may interact for real time decision making with a central cloud sync for the centralized analyzer with different nodes of the global groups or nodes. For example, information may be traced from each device and customized instructions may be sent to nodes and edge adaptors. A resolution vector may be converted to solution based instructions, and a relevant vector may be chosen based on the similarity index. Logs may be analyzed and aggregated to find a pattern in the issue/application and its resolution correlation. This may enable the user to transact and/or use the upgraded application after taking into consideration the resolved and unresolved vectors in augmented reality. The nodes in augmented reality may ensure that the user does not encounter any threats owing to any conflict between real and staged environments. Information may be traced from each system, and customized instructions may be sent to edge adapters with an encrypted history. For example, resolution patterns may be vectorized by application, issue, time, and/or events, and unresolved vectors may be sent to a cloud network seeking resolution or learning. Vectors may be synchronized between edge nodes (e.g., different edge nodes from different groups or organizations) and the cloud, and unresolved vectors may be analyzed/solved using other edge vectors.

Accordingly, described herein is a real-time model representation generation apparatus that uses augmented reality to initiate nodes with edge computing to enable secured protocols for model ingestion in the device. This is an unconventional use of the model representation generation apparatus in augmented reality for intelligent, real-time monitoring of models through a distributed ledger and powered by smart calibration using edge computing techniques.

These and other features are described in further detail below.

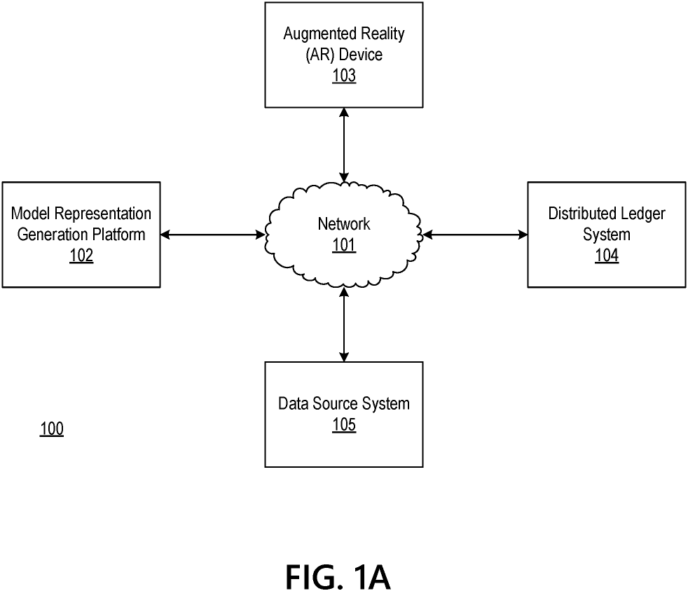

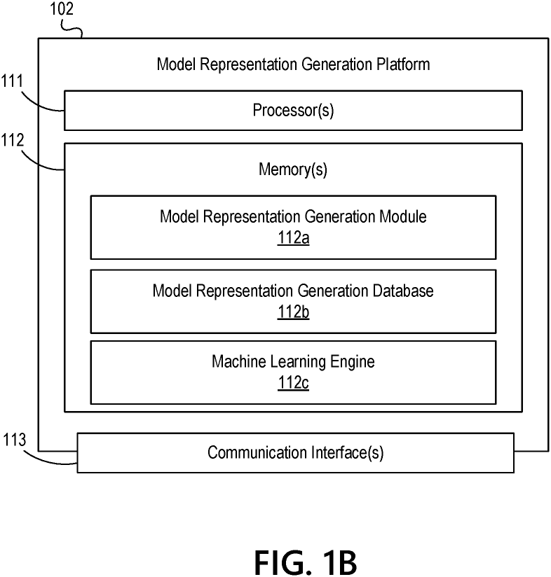

FIGS. 1A-1B depict an illustrative computing environment that provides real time monitoring and smart ingestion of machine learning models using augmented reality in accordance with one or more example embodiments. Referring to FIG. 1A, computing environment 100 may include one or more computer systems. For example, computing environment 100 may include model representation generation host platform 102, augmented reality (AR) device 103, distributed ledger system 104, and data source system 105.

As described further below, model representation generation host platform 102 may be a computer system that includes one or more computing devices (e.g., servers, server blades, or the like) and/or other computer components (e.g., processors, memories, communication interfaces) that may be used to perform real time monitoring and smart ingestion of machine learning models using augmented reality as described further below. In these instances, the model representation generation host platform 102 may be configured to ingest information corresponding to machine learning models, and configure this information for display using augmented reality to enable real time monitoring and understanding of the machine learning models.

AR device 103 may be and/or otherwise include one or more AR capable devices such as a laptop computer, smart watch, desktop computer, mobile device, tablet, smartphone, virtual reality device (e.g., a headset or other device), an augmented reality device (e.g., glasses or other device), and/or other device that may be used by an individual to observe and otherwise interact with information of the machine learning models. In some instances, AR device 103 may be configured to display one or more user interfaces (e.g., augmented reality interfaces, or the like). In some instances, the AR device 103 may be configured with one or more edge nodes (e.g., central edge nodes, local edge nodes, and/or other edge nodes), which may be used to communicate with the model representation generation host platform 102.

Distributed ledger system 104 may be and/or otherwise include one or more computing devices (e.g., servers, server blades, and/or other devices) and/or other computer components (e.g., processors, memories, communication interfaces) that may be used to hold and/or otherwise validate a distributed ledger. For example, the distributed ledger system 104 may maintain a distributed ledger that includes identifiers of selected machine learning models and indications of consent to the selections.

Data source system 105 may be and/or otherwise include one or more computing devices (e.g., servers, server blades, and/or other devices) and/or other computer components (e.g., processors, memories, communication interfaces) that may be used to store machine learning models and any corresponding information or datasets.

Computing environment 100 also may include one or more networks, which may interconnect model representation generation host platform 102, AR device 103, distributed ledger system 104, and/or data source system 105. For example, computing environment 100 may include a network 101 (which may interconnect, e.g., model representation generation host platform 102, AR device 103, distributed ledger system 104, and/or data source system 105).

In one or more arrangements, model representation generation host platform 102, AR device 103, distributed ledger system 104, and/or data source system 105 may be any type of computing device capable of sending and/or receiving requests and processing the requests accordingly. For example, model representation generation host platform 102, AR device 103, distributed ledger system 104, data source system 105, and/or the other systems included in computing environment 100 may, in some instances, be and/or include server computers, desktop computers, laptop computers, enhanced reality devices, tablet computers, smart phones, smart watches, cameras, microphones, and/or other augmented reality devices that may include one or more processors, memories, communication interfaces, storage devices, and/or other components. As noted above, and as illustrated in greater detail below, any and/or all of model representation generation host platform 102, AR device 103, distributed ledger system 104, and/or data source system 105, may in some instances, be special-purpose computing devices configured to perform specific functions.

Referring to FIG. 1B, model representation generation host platform 102 may include one or more processors 111, memory 112, and communication interface 113. A data bus may interconnect processor 111, memory 112, and communication interface 113. Communication interface 113 may be a network interface configured to support communication between model representation generation host platform 102 and one or more networks (e.g., network 101, or the like). Memory 112 may include one or more program modules having instructions that when executed by processor 111 cause model representation generation host platform 102 to perform one or more functions described herein and/or one or more databases that may store and/or otherwise maintain information which may be used by such program modules and/or processor 111. In some instances, the one or more program modules and/or databases may be stored by and/or maintained in different memory units of model representation generation host platform 102 and/or by different computing devices that may form and/or otherwise make up model representation generation host platform 102. For example, memory 112 may have, host, store, and/or include model representation generation module 112a, model representation generation database 112b, and/or machine learning engine 112c.

Model representation generation module 112a may have instructions that direct and/or cause model representation generation host platform 102 to provide real time monitoring and smart ingestion of machine learning models, as discussed in greater detail below. model representation generation database 112b may store information used by model representation generation module 112a and/or model representation generation host platform 102 in application of advanced techniques to perform real time monitoring and smart ingestion of machine learning models, and/or in performing other functions. Machine learning engine 112c may be used by the model representation generation module 112a and/or the model representation generation database 112b to train, maintain, and/or otherwise refine a deep learning engine that may be used to select and/or otherwise recommend machine learning models.

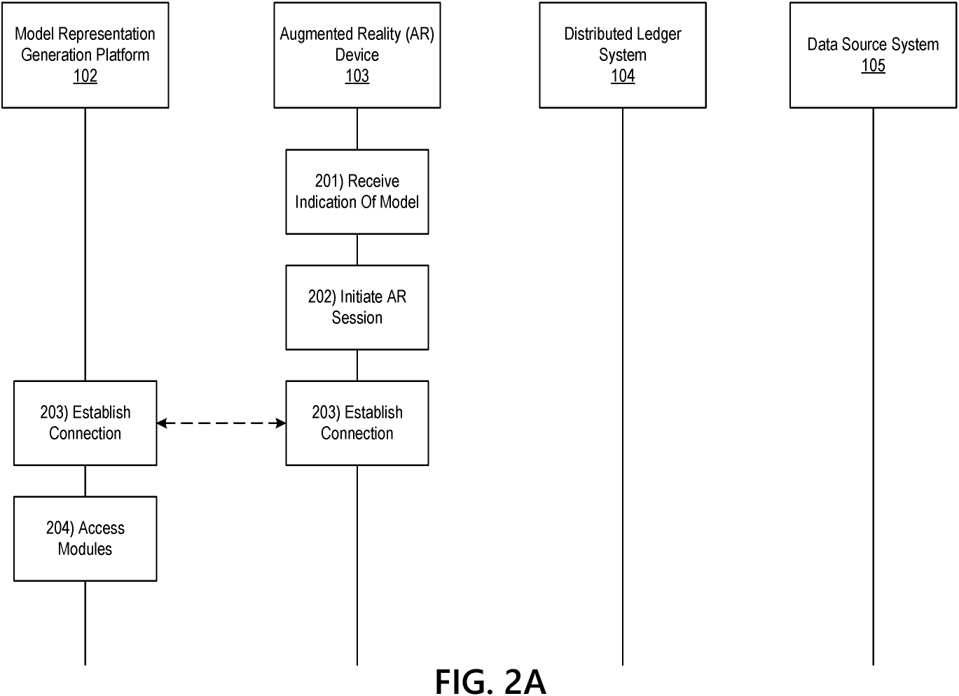

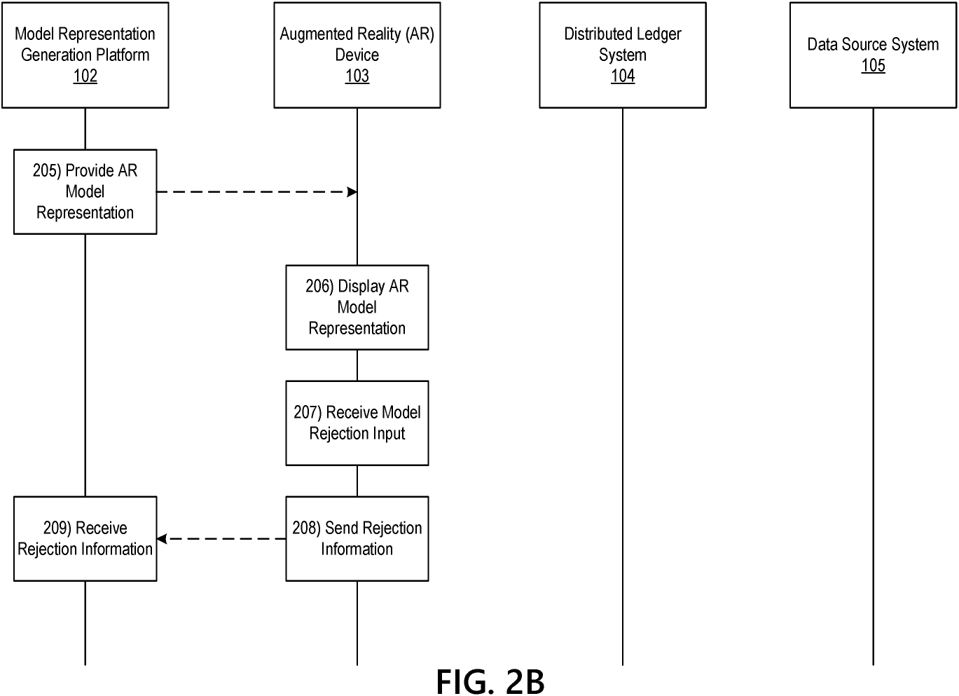

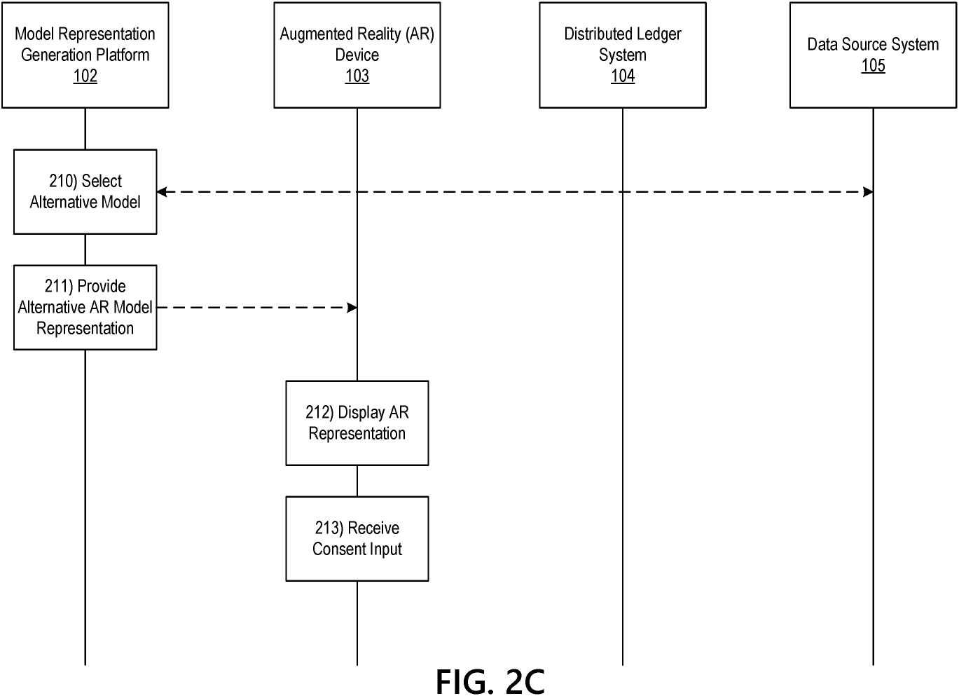

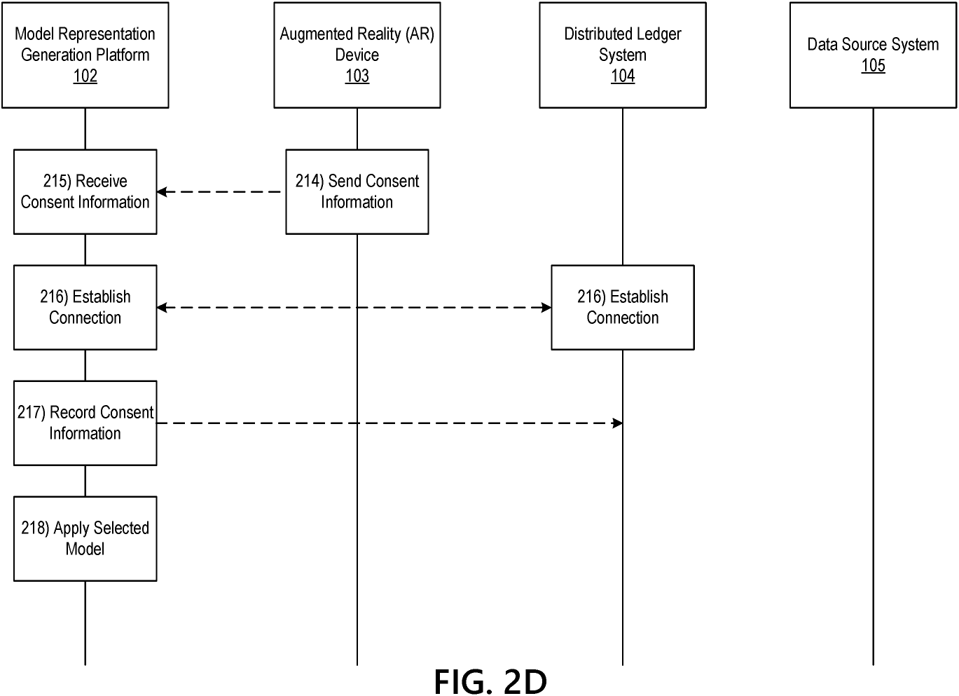

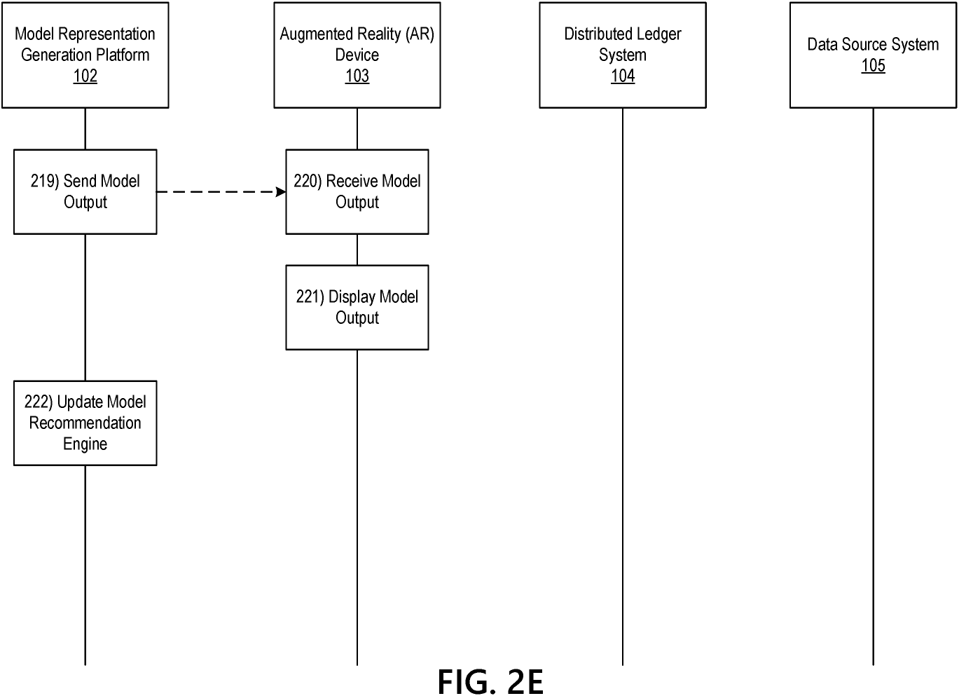

FIGS. 2A-2E depict an illustrative event sequence for real time monitoring and smart ingestion of machine learning models in accordance with one or more example embodiments. Referring to FIG. 2A, at step 201, the AR device 103 may receive an indication of a machine learning model. For example, the AR device 103 may receive an indication of a suggested machine learning model for use in producing an output for a user of the AR device 103 (e.g., selecting financial products (e.g., mutual funds, stocks, index funds, and/or other financial products), selecting a mortgage (e.g., viewing information about different mortgages, providing wealth management recommendations (e.g., various products may have parameters that make users eligible such as account balance, risk tolerance, and/or other parameters) and/or other good/services). In some instances, the AR device 103 may receive the indication of a suggested machine learning model as an unprompted push (e.g., from the model representation generation host platform 102, data source system 105, and/or other system). For example, the model representation generation host platform 102 may push a recommended machine learning model to the AR device 103 to provide an unprompted recommendation. Alternatively, the AR device 103 may request the machine learning model (e.g., from the model representation generation host platform 102, data source system 105, and/or other system) and may receive the indication in response. For example, the AR device 103 may receive user input requesting recommendations, and the model representation generation host platform 102 may push a machine learning model to the AR device 103 for use in providing the recommendations.

At step 202, the AR device 103 may initiate an AR session. For example, the AR device 103 may initiate an AR session based on user input indicating that the AR session should be launched. For example, a user may be wearing AR glasses, and may launch an AR session on the glasses accordingly.

At step 203, the model representation generation host platform 102 may establish a connection with the AR device 103. For example, the model representation generation host platform 102 may establish a first wireless data connection with the AR device 103 to link the model representation generation host platform 102 to the AR device 103 (e.g., in preparation for providing an AR model representation). In some instances, the model representation generation host platform 102 may identify whether or not a connection is already established with the AR device 103. If a connection is already established with the AR device 103, the model representation generation host platform 102 might not re-establish the connection. If a connection is not yet established with the AR device 103, the model representation generation host platform 102 may establish the first wireless data connection as described herein.

At step 204, the model representation generation host platform 102 may access one or more modules, stored or otherwise hosted by the model representation generation host platform 102 that may enable the model representation generation host platform 102 to facilitate an AR representation of the machine learning model at the AR device 103. For example, the model representation generation host platform 102 may access one or more of a resolver, a data collector, an analyzer, script files, a parameter engine, a scheduler, metadata, and/or other modules. In some instances, the model representation generation host platform 102 may be configured to access both local and cloud based data. In either instance, the model representation generation host platform 102 may utilize edge nodes (e.g., central edge nodes, local edge nodes, and/or other edge nodes) to reduce a communication distance between the model representation generation host platform 102 and the cloud/local data storage systems so as to reduce corresponding response times.

In accessing the various modules, the model representation generation host platform 102 may tag or otherwise log information of a plurality of machine learning models. In some instances, the model representation generation host platform 102 may store these information logs at the data source system 105, which may, e.g., be or include one or more edge servers/nodes. In tagging/logging the information of the plurality of machine learning models, the model representation generation host platform 102 may store data and/or other parameters of the models that may be used to produce an AR representation of the models. For example, the model representation generation host platform 102 may store vector information that may be used by nodes for approval, learning, cloud collaboration, and/or otherwise, and may store the information logs using the one or more edge nodes.

Referring to FIG. 2B, at step 205, the model representation generation host platform 102 may communicate with the AR device 103 to provide an AR model representation. For example, the model representation generation host platform 102 may provide the AR device 103 with AR model representation information and one or more commands directing the AR device 103 to display the AR model representation. In some instances, in providing the AR model representation information, the model representation generation host platform 102 may first select a machine learning model based on the user of the AR device 103 and/or a task to be performed. In selecting the machine learning mode, the model representation generation host platform 102 may select a supervised machine learning model (e.g., boosting, decision tree, classifier, nearest neighbor, support vector machines, random forest, and/or other supervised model), unsupervised machine learning model (clustering, anomaly detection, and/or other unsupervised models), and/or other type of machine learning model. Once a machine learning model is selected, the model representation generation host platform 102 may dissect the machine learning model, using the parameter module accessed at step 204 and using one or more scripts, to identify operations, parameters, and/or other insights of the machine learning model (e.g., local privacy information, global privacy information, fairness, non-variability, hidden beneficiaries, and/or other information).

Additionally or alternatively, the model representation generation host platform 102 may use the instant resolver module, loaded at step 204, to perform real time decision making, with a central cloud sync for the centralized analyzer module, also loaded at step 204, with different nodes or groups. For example, information may be traced from each device (e.g., AR device 103), and customized instructions may be sent to nodes and edge adaptors (which may, e.g., configure the AR device 103 to track and/or otherwise implement the machine learning model. In doing so, these edge nodes/adaptors may act as micro edges containing most frequently used vectors. In some instances, resolution vectors may be converted to solution based instructions, and the relevant vector may be chosen based on a similarity index. Logs may be analyzed and aggregated to find a pattern in model application and resolution correlations.

As an example, the model representation generation host platform 102 may display, to the user, input information that may be fed into the machine learning model, thus enabling the user to determine whether or not they consent to providing or otherwise inputting such information. In some instances, the model representation generation host platform 102 may communicate with the AR device 103 via one or more edge nodes (e.g., central edge nodes, local edge nodes, and/or other edge nodes), via the communication interface 113, and/or while the first wireless data connection is established. For example, by communicating via such edge nodes, the model representation generation host platform 102 may improve performance by reducing the corresponding communication distances (which may, e.g., allow the model representation generation host platform 102 to more quickly communicate with the AR device 103 and provide quicker recommendations).

At step 206, based on or in response to the one or more commands directing the AR device 103 to display the AR model representation, the AR device 103 may display the AR model representation. For example, the AR device 103 may display an augmented reality depiction of the machine learning model that allows a user of the AR device 103 to observe operations and predicted outputs of the machine learning model, observe resolved and/or unresolved vectors of the machine learning model, and/or otherwise interact with the machine learning model. For example, the user may provide user input that may manipulate the machine learning model. In doing so, the AR device 103 may enable the user to observe and understand what algorithm/model was selected, why it was selected, operation of the model, and what the outcome of the algorithm/model is (e.g., a preview of an output from the model), thus making model selection more transparent and explainable to the user. In some instances, the user may interact with the AR model representation (e.g., transacting, using the model on the fly after taking into consideration any resolved and/or unresolved vectors). For example, the user may interact with the AR model representation using the AR device 103. In some instances, in interacting with the AR model representation, the user may input a selection of an alternative ML model. The AR device 103 may ensure that the user does not encounter threats due to conflicts between real or staged environments. In some instances, resolution patterns may be vectorized by application, issue, time, event, and/or other information, and any unresolved vectors may be sent to a cloud network seeking resolution or learning. These vectors may be synchronized between edge nodes and the cloud, and unresolved vectors may be solved using other edge vectors.

At step 207, the AR device 103 may receive a model rejection input. For example, the AR device may receive an input indicating that the machine learning model should not be selected (e.g., based on the interaction with the AR model representation) or otherwise applied, and that consent is not given to apply the machine learning model. In some instances, a consent input may instead be received (e.g., as described at step 213). In these instances, the event sequence may proceed to step 213. In some instances, in addition or as an alternative to receiving the model rejection input, the AR device 103 may receive information requesting additional information about the machine learning model, and may provide such additional information accordingly.

Although steps 207-212 (describing the model rejection scenario) and steps 213-221 (describing the consent scenario) are depicted in sequence, the two processes may be performed in a loop without departing from the scope of the disclosure. For example, steps 207-212 may be performed one or more times in a loop until consent is received, at which point steps 213-221 may be performed.

At step 208, the AR device 103 may send rejection information, indicating that consent has not been received for the machine learning model, to the model representation generation host platform 102. In some instances, the AR device 103 may send the rejection information while the first wireless data connection is established. In some instances, in sending the rejection information to the model representation generation host platform 102, the AR device 103 may communicate via one or more edge nodes (e.g., central edge nodes, local edge nodes, and/or other edge nodes).

At step 209, the model representation generation host platform 102 may receive the rejection information sent at step 208. For example, the model representation generation host platform 102 may receive the rejection information via the communication interface 113 and while the first wireless data connection is established.

Referring to FIG. 2C, at step 210, the model representation generation host platform 102 may select an alternative machine learning model. For example, the model representation generation host platform 102 may select the alternative machine learning model based on characteristics of the user, a task to be performed, feedback information on the machine learning model, and/or otherwise. In some instances, to select the alternative machine learning model, the model representation generation host platform 102 may communicate with the data source system 105, which may, e.g., store information of the machine learning models. Additionally, or alternatively, the model representation generation host platform 102 may communicate with the distributed ledger system 104 to access information of the machine learning models (e.g., via one or more edge nodes). For example, by communicating via such edge nodes, the model representation generation host platform 102 may improve performance by reducing the corresponding communication distances (which may, e.g., allow the model representation generation host platform 102 to more quickly communicate with the AR device 103 and provide quicker recommendations).

At step 211, the model representation generation host platform 102 may provide an alternative AR model representation to the AR device 103. For example, the model representation generation host platform 102 may generate an AR model of the alternative machine learning model, which may, e.g., be similar to the AR model representation provided at step 205, but that is representative of the alternative machine learning model rather than the machine learning model.

For example, the model representation generation host platform 102 may communicate with the AR device 103 to provide the alternative AR model representation. In some instances, the model representation generation host platform 102 may provide the AR device 103 with alternative AR model representation information and one or more commands directing the AR device 103 to display the alternative AR model representation. Once the alternative machine learning model is selected, the model representation generation host platform 102 may dissect the alternative machine learning model to identify operations, parameters, and/or other insights of the alternative machine learning model (e.g., local privacy information, global privacy information, fairness, non-variability, hidden beneficiaries, and/or other information). In some instances, the model representation generation host platform 102 may communicate with the AR device 103 via one or more edge nodes (e.g., central edge nodes, local edge nodes, and/or other edge nodes), via the communication interface 113, and/or while the first wireless data connection is established.

At step 212, based on or in response to the one or more commands directing the AR device 103 to display the alternative AR model representation, the AR device 103 may display the alternative AR model representation. For example, the AR device 103 may display an augmented reality depiction of the machine learning model that allows the user of the AR device 103 to observe operations and predicted outputs of the machine learning model, observe resolved and/or unresolved vectors of the machine learning model, and/or otherwise interact with the machine learning model. For example, the user may provide user input that may manipulate the alternative machine learning model. In doing so, the AR device 103 may enable the user to observe and understand what algorithm/model was selected, why it was selected, and what the outcome of the algorithm/model is, thus making model selection more transparent and explainable to the user.

In some instances, in displaying the alternative AR model representation, the model representation generation host platform 102 may dissect the machine learning model to identify operations, parameters, and/or other insights of the machine learning model (e.g., local privacy information, global privacy information, fairness, non-variability, hidden beneficiaries, and/or other information). As an example, the model representation generation host platform 102 may display, to the user, input information that may be fed into the alternative machine learning model, thus enabling the user to determine whether or not they consent to providing or otherwise inputting such information. In some instances, the model representation generation host platform 102 may communicate with the AR device 103 via one or more edge nodes (e.g., central edge nodes, local edge nodes, and/or other edge nodes), via the communication interface 113, and/or while the first wireless data connection is established. For example, by communicating via such edge nodes, the model representation generation host platform 102 may improve performance by reducing the corresponding communication distances (which may, e.g., allow the model representation generation host platform 102 to more quickly communicate with the AR device 103 and provide quicker recommendations).

At step 213, the AR device 103 may receive a consent input from the user, indicating the user’s consent to apply the alternative machine learning model (or in instances where consent to apply the machine learning model was received, the machine learning model may be applied). For example, the AR device 103 may receive a voice input, gesture input, touch input, and/or other input indicating the user’s consent. Additionally or alternatively, the consent input may be received by a different device of the user (e.g., a mobile device, laptop, tablet, smartphone, and/or other device, different than the AR device 103).

Referring to FIG. 2D, at step 214, the AR device 103 may send consent information, indicating consent has been received to apply the alternative machine learning model to the model representation generation host platform 102. For example, the AR device 103 may send the consent information to the model representation generation host platform 102 via the communication interface 113 and while the first wireless data connection is established.

At step 215, the model representation generation host platform 102 may receive the consent information sent at step 214. For example, the model representation generation host platform 102 may receive the consent information via the communication interface 113, while the first wireless data connection is established, and/or via one or more edge nodes (e.g., central edge nodes, local edge nodes, and/or other edge nodes).

At step 216, the model representation generation host platform 102 may establish a connection with the distributed ledger system 104. For example, the model representation generation host platform 102 may establish a second wireless data connection with the distributed ledger system 104 to link the distributed ledger system 104 to the model representation generation host platform 102 (e.g., in preparation for recording the consent information to a distributed ledger hosted by the distributed ledger system 104). In some instances, the model representation generation host platform 102 may identify whether or not a connection is already established with the distributed ledger system 104. If a connection is already established with the distributed ledger system 104, the model representation generation host platform 102 might not re-establish the connection. If a connection is not yet established with the distributed ledger system 104, the model representation generation host platform 102 may establish the second wireless data connection as described herein.

At step 217, the model representation generation host platform 102 may record the consent information to the distributed ledger hosted by the distributed ledger system 104. For example, the model representation generation host platform 102 may record the consent information via the communication interface 113, while the second wireless data connection is established, and/or via one or more edge nodes (e.g., central edge nodes, local edge nodes, and/or other edge nodes). In some instances, in recording the consent information, the model representation generation host platform 102 may record the consent information to a distributed ledger such as a blockchain, holo-chain, merkle tree, and/or other distributed ledger or consent mechanism hosted by the distributed ledger system 104. For example, in some instances, the model representation generation host platform 102 may create a new block or node of the distributed ledger (e.g., modify the distributed ledger), and may record the consent information in the new block accordingly. In some instances, in addition to recording the consent information, the model representation generation host platform 102 may also record any rejection information received. In some instances, in accessing the distributed ledger, the model representation generation host platform 102 may communicate via one or more edge nodes (e.g., central edge nodes, local edge nodes, and/or other edge nodes) to reduce the communication distance and improve communication speed accordingly.

Accordingly, by recording the consent information and/or rejection information to the distributed ledger, the model representation generation host platform 102 may provide a history of all interactions between a plurality/variety of different devices (including the AR device 103) interacting with various models (e.g., the machine learning model and the alternative machine learning model) that may be used to provide proof of legal consent. Additionally, because distributed ledgers are configured/capable of storing a large amount of data, storing such data in a distributed ledger may reduce storage space needed at local data sources and/or the model representation generation host platform 102 itself. As yet an additional benefit, the distributed ledger may provide peer to peer verification, and once consent is received, the distributed ledger system 104 may validate the consent information using one or more nodes of the distributed ledger accordingly.

As indicated above, although the illustrative event sequence shows rejection of an initial machine learning model and selection of the alternative machine learning model, this is for illustrative purposes only, and the initial machine learning model may be accepted, or any number of alternative machine learning models may be displayed to the user without departing from the scope of this disclosure. Additionally, although consent is shown for a single machine learning model, this is for illustrative purposes only, and any number of machine learning models may be consented to without departing from the scope of the disclosure. For example, the user of the AR device may consent to a first model for performance of a first task and a second model for performance of a second task.

At step 218, the model representation generation host platform 102 may apply the selected machine learning model (e.g., the alternative machine learning model, the machine learning model, and/or any machine learning model for which consent was received). For example, the model representation generation host platform 102 may input user information, task information, and/or other information into the selected machine learning model, and use the machine learning model to produce an output. For example, the model representation generation host platform 102 may use the machine learning model to select financial products, mortgages, accounts, and/or other products/services for the user. In some instances, in applying the selected machine learning model, the model representation generation host platform 102 may communicate in real time with the AR device 103 to cause the AR device 103 to display application/operation of the selected machine learning model.

Referring to FIG. 2E, at step 219, the model representation generation host platform 102 may send the model output produced by the selected machine learning model at step 218. For example, the model representation generation host platform 102 may send information of financial products, mortgages, accounts, and/or other products/services. In some instances, the model representation generation host platform 102 may send the model output to the AR device via the communication interface 113, while the first wireless data connection is established, and/or via one or more edge nodes (e.g., central edge nodes, local edge nodes, and/or other edge nodes). In some instances, in addition or as an alternative to sending the model output to the AR device 103, the model representation generation host platform 102 may send the model output to another device corresponding to the user (e.g., a mobile device, smartphone, smartwatch, tablet, laptop, and/or other device). In some instances, the model representation generation host platform 102 may also send one or more commands directing the AR device 103 to display the model output.

At step 220, the AR device 103 may receive the model output sent at step 219. For example, the AR device 103 may receive the model output while the first wireless data connection is established. In some instances, in addition to the model output, the AR device 103 may receive one or more commands directing the AR device 103 to display the model output. As described above at step 219, in some instances, step 220 may be performed by a device different than the AR device 103 (e.g., another computing device associated with the user).

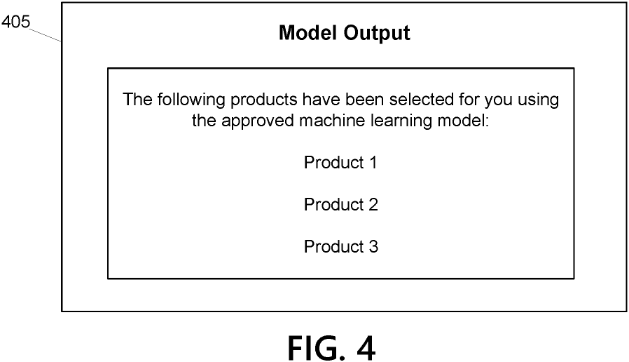

At step 221, based on or in response to the one or more commands directing the AR device 103 to display the model output, the AR device 103 may display the model output. For example, the AR device 103 may display a graphical user interface similar to graphical user interface 405, which is shown in FIG. 4. For example, the AR device 103 may display a number of recommended financial products for the user. In some instances, the AR device 103 may also display benefits corresponding to each recommendation.

At step 222, the model representation generation host platform 102 may update a model used to perform initial model selection (e.g., a model used to select the machine learning model depicted in the AR model representation provided at step 205). In some instances, updating the model may include updating one or more modules accessed at step 204. For example, the model representation generation host platform 102 may utilize consent or rejection information, received from the AR device 103 to refine or otherwise iteratively reinforce the model so as to reduce a number of rejected models provided to the user in the future. As a specific example, the model representation generation host platform 102 may refine the model to prevent initial recommendation of the machine learning model for the user, and reinforce the model to provide initial recommendations of the alternative machine learning model for the user. In some instances, the model representation generation host platform 102 may refine/reinforce the model on a task specific basis (e.g., for recommending financial products, mortgages, and/or performing other tasks), user specific basis (e.g., for different users, sets of users, and/or other groups), and/or other basis. In doing so, the model representation generation host platform 102 may improve performance of this model selection model, so as to conserve resources (e.g., by reducing back and forth communications between the model representation generation host platform 102, reducing generation/display of alternative AR model representations, and/or otherwise improving efficiency of the model selection process).

Accordingly, by operating in this way, the model representation generation host platform 102 provides the benefits of both AR and distributed ledgers in the process of model selection. For example, by utilizing AR, the user may be immersed into a suggested model, which may allow them to understand a deconstructed view of the model through an enhanced AR experience, which would not be the case if AR were not utilized. For example, users may see how models work in a way that they would not be able to in an alternative display. Additionally, by implementing the distributed ledger, a more secure and legally binding method for data storage is described, which may be forensically verifiable. Furthermore, the distributed ledger may be accessed to provide historical information of a model to users, which may provide additional insights.

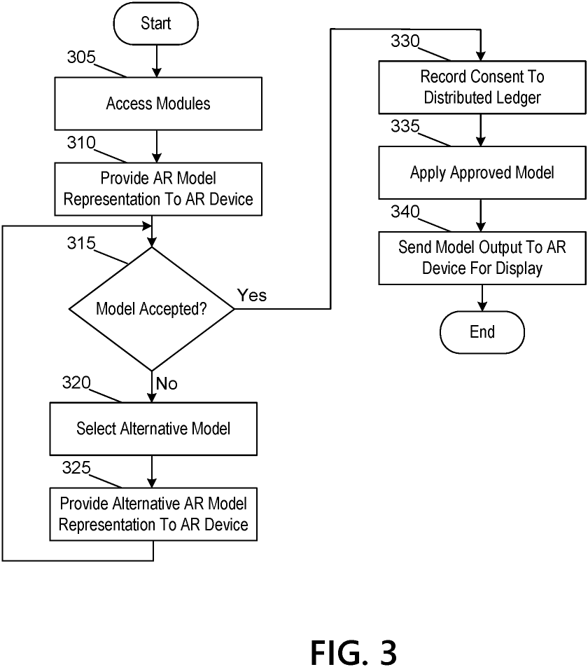

FIG. 3 depicts an illustrative method for real time monitoring and smart ingestion of machine learning models in accordance with one or more example embodiments. Referring to FIG. 3, at step 305, a computing platform having at least one processor, a communication interface, and memory may access one or more model representation generation modules. At step 310, the computing platform may use the one or more model representation generation modules to provide an AR model representation to an AR client device. At step 315, the computing platform may identify whether or not the model, corresponding to the AR model representation, is accepted. If the model is accepted, the computing platform may proceed to step 330. If the model is not accepted, the computing platform may proceed to step 320.

At step 320, the computing platform may select an alternative model. At step 325, the computing platform may provide an alternative AR model representation to the AR client device and the process may return to step 315 to determine whether the alternative AR model is accepted.

If the model (or the alternative model) is accepted, at step 330, the computing platform may record consent to use the model to a distributed ledger. At step 335, the computing platform may apply to approved model. At step 340, the computing platform may send an output of the approved model to the AR client device for display.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
select, once an augmented reality (AR) session has been established with an AR client device, a machine learning (ML) model, wherein the ML model is configured to produce an output based on user information;
send, to the AR client device, an AR representation of the ML model, wherein the AR representation of the ML model illustrates, using AR, operation of the ML model;
receive, from the AR client device, consent information indicating whether or not consent is provided to apply the ML model;
based on identifying that consent has been received:
write, to a distributed ledger, the consent information and an identifier of the ML model;
apply the ML model, wherein applying the ML model produces a ML output for a user of the AR client device; and
send, to the AR client device, one or more commands directing the AR client device to display the ML output, wherein sending the one or more commands directing the AR client device to display the ML output causes the AR client device to display the ML output; and
based on identifying that consent has not been received:
select an alternative machine learning model, wherein the alternative ML model is configured to produce the output based on the user information,
send, to the AR client device, an AR representation of the alternative ML model, wherein the AR representation of the alternative ML model illustrates, using AR, operation of the ML model,
receive, from the AR client device, second consent information indicating that consent is provided to apply the alternative ML model,
write, to the distributed ledger, the second consent information and an identifier of the alternative ML model,
apply the alternative ML model, wherein applying the alternative ML model produces an alternative ML output customized based on the user of the AR client device, and
send, to the AR client device, one or more commands directing the AR client device to display the alternative ML output, wherein sending the one or more commands directing the AR client device to display the alternative ML output causes the AR client device to display the alternative ML output.

2. The computing platform of claim 1, wherein the AR representation of the ML model is configured to be manipulated based on user input received via the AR client device, wherein the manipulation of the AR representation further illustrates the operation of the ML model.

3. The computing platform of claim 2, wherein the user input comprises selection of the alternative ML model.

4. The computing platform of claim 3, wherein the memory stores additional computer-readable instructions that, when executed by the at least one processor, cause the computing platform to:
receive an indication of the selection of the alternative ML model; and
update the AR representation of the ML model based on the selection of the alternative ML model, wherein updating the AR representation of the ML model configures the AR representation of the ML model to illustrate operation of the alternative ML model.

5. The computing platform of claim 1, wherein the AR client device comprises one or more of: a mobile device, a tablet device, or AR glasses.

6. The computing platform of claim 1, wherein the distributed ledger comprises one of: a blockchain or a holo-chain.

7. The computing platform of claim 1, wherein the AR session is established in response to receipt of an unprompted indication of the ML model.

8. The computing platform of claim 1, wherein the AR session is established in response to selection of the ML model by the user of the AR client device.

9. The computing platform of claim 1, wherein the AR client device comprises one or more edge nodes, and wherein communication between the computing platform and the AR client device occurs via the one or more edge nodes.

10. The computing platform of claim 1, wherein illustrating the operation of the ML model comprises illustrating a preview of the ML output.

11. A method comprising:
at a computing platform comprising at least one processor, a communication interface, and memory:
selecting, once an augmented reality (AR) session has been established with an AR client device, a machine learning (ML) model, wherein the ML model is configured to produce an output based on user information;
sending, to the AR client device, an AR representation of the ML model, wherein the AR representation of the ML model illustrates, using AR, operation of the ML model;
receiving, from the AR client device, consent information indicating whether or not consent is provided to apply the ML model;
based on identifying that consent has been received:
writing, to a distributed ledger, the consent information and a identifier of the ML model,
applying the ML model, wherein applying the ML model produces a ML output customized based on a user of the AR client device, and
sending, to the AR client device, one or more commands directing the AR client device to display the ML output, wherein sending the one or more commands directing the AR client device to display the ML output causes the AR client device to display the ML output; and
based on identifying that consent has not been received:
selecting an alternative machine learning model, wherein the alternative ML model is configured to produce the output based on the user information,
sending, to the AR client device, an AR representation of the alternative ML model, wherein the AR representation of the alternative ML model illustrates, using AR, operation of the ML model,
receiving, from the AR client device, second consent information indicating that consent is provided to apply the alternative ML model,
writing, to the distributed ledger, the second consent information and an identifier of the alternative ML model,
applying the alternative ML model, wherein applying the alternative ML model produces an alternative ML output customized based on the user of the AR client device, and
sending, to the AR client device, one or more commands directing the AR client device to display the alternative ML output, wherein sending the one or more commands directing the AR client device to display the alternative ML output causes the AR client device to display the alternative ML output.

12. The method of claim 11, wherein the AR representation of the ML model is configured to be manipulated based on user input received via the AR client device, wherein the manipulation of the AR representation further illustrates the operation of the ML model.

13. The method of claim 12, wherein the user input comprises selection of the alternative ML model.

14. The method of claim 13, further comprising:
receiving an indication of the selection of the alternative ML model; and
updating the AR representation of the ML model based on the selection of the alternative ML model, wherein updating the AR representation of the ML model configures the AR representation of the ML model to illustrate operation of the alternative ML model.

15. The method of claim 11, wherein the AR client device comprises one or more of: a mobile device, a tablet device, or AR glasses.

16. The method of claim 11, wherein the distributed ledger comprises one of: a blockchain or a holo-chain.

17. The method of claim 11, wherein the AR session is established in response to receipt of an unprompted indication of the ML model.

18. The method of claim 11, wherein the AR session is established in response to selection of the ML model by the user of the AR client device.

19. The method of claim 11, wherein the AR client device comprises one or more edge nodes, and wherein communication between the computing platform and the AR client device occurs via the one or more edge nodes.

20. One or more non-transitory computer-readable media storing instructions that, when executed by a computing platform comprising at least one processor, a communication interface, and memory, cause the computing platform to:
select, once an augmented reality (AR) session has been established with an AR client device, a machine learning (ML) model, wherein the ML model is configured to produce an output based on user information;
send, to the AR client device, an AR representation of the ML model, wherein the AR representation of the ML model illustrates, using AR, operation of the ML model;
receive, from the AR client device, consent information indicating whether or not consent is provided to apply the ML model;
based on identifying that consent has been received:
write, to a distributed ledger, the consent information and a identifier of the ML model,
apply the ML model, wherein applying the ML model produces a ML output customized based on a user of the AR client device, and
send, to the AR client device, one or more commands directing the AR client device to display the ML output, wherein sending the one or more commands directing the AR client device to display the ML output causes the AR client device to display the ML output; and
based on identifying that consent has not been received:
select an alternative machine learning model, wherein the alternative ML model is configured to produce the output based on the user information,
send, to the AR client device, an AR representation of the alternative ML model, wherein the AR representation of the alternative ML model illustrates, using AR, operation of the ML model,
receive, from the AR client device, second consent information indicating that consent is provided to apply the alternative ML model,
write, to the distributed ledger, the second consent information and a identifier of the alternative ML model,
apply the alternative ML model, wherein applying the alternative ML model produces an alternative ML output customized based on the user of the AR client device, and
send, to the AR client device, one or more commands directing the AR client device to display the alternative ML output, wherein sending the one or more commands directing the AR client device to display the alternative ML output causes the AR client device to display the alternative ML output.
